(19) United States
(12) Patent Application Publication
(10) Pub. No.: US 2014/0279687 A1
(43) Pub. Date: Sep. 18, 2014

(54) SYSTEM AND METHOD FOR PLAN INVESTMENT MANAGEMENT

(71) Applicant: JOHN HANCOCK LIFE INSURANCE COMPANY (U.S.A.), Boston, MA (US)

(72) Inventors: Valerie D'ANDREA, Toronto (CA); Amie KHONDO, Toronto (CA); Kylan VANWICKLIN, Toronto (CA)

(73) Assignee: JOHN HANCOCK LIFE INSURANCE COMPANY (U.S.A.), Boston, MA (US)

(21) Appl. No.: 13/842,028

(22) Filed: Mar. 15, 2013

(51) Int. Cl. G06Q 40/06

(52) U.S. Cl. CPC G06Q 40/06
USPC 705/36 R

(57) ABSTRACT

A method and system for plan investment management are provided. The method includes: determining criteria for analysis of a plurality of funds; weighting the criteria; analyzing the plurality of funds, wherein analyzing includes: retrieving fund data with respect to each fund of the plurality of funds; analyzing the fund data in relation to the weighted criteria; ranking each fund based on the analysis. The method also includes: reporting the ranking of each fund of the plurality of funds; and selecting funds for the plan. The system includes: a monitoring module for retrieving fund data with respect to each fund of a plurality of funds; an analysis module configured to determine and weight criteria for analysis of each fund within the plurality of funds, the analysis module further configured to analyze the fund data in relation to the weighted criteria and rank each fund based on the analysis; a reporting module configured to rank each fund within the plurality of funds; and a selection component configured to select funds for the plan.

### FIELD

The present disclosure relates generally to plan investment management. More particularly, the present disclosure relates to a system and method for plan investment management and fund analysis.

### BACKGROUND

Many employers have previously established or consider establishing investment or retirement plans, such as employee retirement plans or profit sharing plans in order to further compensate employees. These plans need to be managed with care, skill, prudence and diligence. In some cases, these investment or retirement plans may be subject to the Employee Retirement Income Security Act of 1974 (ERISA), which would require plan fiduciaries to manage the plan investments prudently. The plan investments should also be selected and monitored to ensure diversification of the funds offered under the plan. Typically, these investment or retirement plans will have a plan administrator or plan manager with responsibilities for the plan, sometimes referred to as a plan trustee or a Responsible Plan Fiduciary (RPF).

The RPF must be able to monitor the funds in the plan to ensure that the appropriate funds are selected and that funds that may no longer be meeting the objectives of the plan can be reviewed and potentially eliminated from the plan. Providers of plan investment products are often reluctant to risk being classified (either directly or indirectly) as investment fiduciaries for these investment or retirement plans and, as such, may provide only limited monitoring services for plan level funds, leaving this to the plan manager.

As such, there is a need for improved systems and methods for helping RPF's manage group investment and retirement plans.

### SUMMARY

It is, therefore, desirable to provide a method and system for plan investment management and fund analysis designed to mitigate at least one disadvantage of conventional systems and methods.

In a first aspect, the present disclosure provides a method for plan investment management including: determining criteria for analysis of a plurality of funds; weighting the criteria; analyzing the plurality of funds, wherein analyzing includes: retrieving fund data with respect to each fund of the plurality of funds; analyzing the fund data in relation to the weighted criteria; ranking each fund based on the analysis. The method also includes: reporting the ranking of each fund of the plurality of funds; and selecting funds for the plan.

In some cases, the method includes determining at least one alternative fund for any underperforming fund that ranks below a predetermined threshold ranking.

In a particular case, the method includes preparing plan participant notification packages comprising detail on the at least one alternative fund and the underperforming fund.

In some cases, the method includes processing a change from the underperforming fund to the at least one alternative fund.

In a particular case, the change is processed on an effective date wherein the effective date is within a required notice period.

In some cases, the method also tracks plan participants who select to opt out of the fund change.

In some cases, the ranking of the plurality of funds is used to determine an initial fund line-up for a plan.

In some cases, the criteria are predetermined criteria. In other cases, the criteria are custom criteria as selected by a plan administrator.

In some cases, the weighting of the criteria is determined based on a predefined set of criteria options.

In another aspect, there is provided a system for plan investment management. The system includes: a monitoring module for retrieving fund data with respect to each fund of a plurality of funds; an analysis module configured to determine and weight criteria for analysis of each fund within the plurality of funds, the analysis module further configured to analyze the fund data in relation to the weighted criteria and rank each fund based on the analysis; a reporting module configured to rank each fund within the plurality of funds; and a selection component configured to select funds for the plan.

In some cases, the analysis module is further configured to determine at least one alternative fund for any underperforming fund which ranks below a predetermined threshold ranking.

In a particular case, the reporting module if further configured to prepare plan participant notification packages comprising detail on the at least one alternative fund and the underperforming fund.

In some cases, the system includes a processing module configured to process a change from the underperforming fund to the at least one alternative fund.

In some cases, the change is processed on an effective date wherein the effective date is within a required notice period.

In a particular case, the system also includes a memory module configured to track plan participants who select to opt out of the fund change.

In some cases, the selection component is further configured to use the ranking of the plurality of funds to determine an initial fund line-up for a plan.

In the some cases, the criteria are predetermined criteria. In other cases, the criteria are custom criteria as selected by a plan administrator.

In some cases, the weighting of the criteria is determined based on a predefined set of criteria options.

In some cases, the plan will be a retirement plan.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 illustrates an embodiment of a system for plan investment management;

FIG. 2 is a flowchart of an embodiment of a method for establishing an initial plan; and

FIG. 3 is a flowchart of an embodiment of a method for plan review and analysis.

### DETAILED DESCRIPTION

Generally, the present disclosure provides embodiments of a method and system for plan investment management. In particular, the system is configured to allow selection of criteria and criteria options and then monitor and analyze funds against criteria and criteria options. The system monitors the funds and gathers fund data from a plurality of external systems. If a fund no longer meets the criteria and/or criteria options and appears to be underperforming, the system may select possible replacement funds for consideration by a plan administrator or Responsible Plan Fiduciary (RPF) to replace the underperforming fund.

The ERISA requires the fiduciaries of every retirement plan, for example, a 401(k), Profit Sharing, or the like, to manage the plan assets with care, skill, prudence and diligence and to ensure diversification of the funds offered under the plan so as to minimize the risk of large losses to plan participants. An Investment Policy Statement (IPS) formally documents these fiduciary responsibilities and describes the procedures, investment philosophy, guidelines and constraints to be used by the plan's fiduciaries.

For the embodiments disclosed herein, the plans referred to are retirement plans and the plan administrator is referred to as an RPF, however, it will be understood that the system and method may be used by other investment plans run by a plan administrator with or without a fiduciary duty to the plan.

An IPS is intended to set out the objectives, restrictions, funding requirements, and general investment structure for the management of the plan's assets, and to provide the basis for evaluating the Plan's investments on a regular basis. An IPS may further establish a set of quantitative criteria to be used in the initial selection and ongoing monitoring of the plan's investment options (Funds).

FIG. 1 illustrates an embodiment of a system 100 for plan investment management. The system 100 is intended to provide fiduciary support services that help plan administrators or RPFs in the initial selection and ongoing monitoring of funds available under the RPFs plan. Each RPF may access the system 100 with a computer 110 via a network 120. The computer 110 may be a personal computer, a tablet computer, a smart phone or the like. The network 120 may be the Internet, a local area network (LAN), a wide area network (WAN), a personal area network (PAN), an enterprise network, a virtual private network (VPN), or the like. In some cases, the RPF may access the system 100 directly by accessing the system locally by, for example, using a computing device hosting the system 100. In some cases, the system 100 may be accessed by a representative of the entity hosting the system 100, for example, the system 100 may be accessed by a computer 110 or terminal located in a field office.

The system 100 includes a connection module 130 which transmits to and receives data from the network 120. The connection module 130 is operatively connected to a processor 140. The processor 140 may be a separate processor for the system 100 or may be a central processor unit for the computer hosting the system 100. The processor 140 is configured to execute the instructions of the modules and components of the system 100.

The connection module 130 is further connected to a monitoring module 150. The monitoring module 150 is configured to monitor a plurality of funds and to collect fund data, such as metrics measurements that may be used to assess and analyze the funds. The monitoring module 150 is operatively connected to an analysis module 160 which is adapted to analyze the metrics measurements with respect to the plurality of funds against predetermined criteria with respect to each plan. The monitoring module 150 may be operatively connected to external fund systems, via the connection module 130. The monitoring module 150 is configured to retrieve fund data from external sources, wherein the external fund data is used in the analysis of the funds available to the plan.

The analysis module 160 includes a selection component 170. The selection component 170 is configured to select and rank the analyzed funds that match each plan's criteria. The monitoring module 150 and analysis module 160 may further be operatively connected to a memory module 180, such as at least one database. The memory module 180 is designed to store data related to, for example, the plans, the funds, the measurements, the criteria, and the like.

The system 100 further includes a reporting module 190. The reporting module 190 is configured to report the results of analysis of the selected funds to each RPF with respect to each plan. The RPF may receive periodic reports generated by the reporting module 190 based on the analysis of the plan. The RPF may further receive reports for an initial plan set up.

The reporting module 190 is further configured to produce notification packages to plan participants of the plans (i.e. end user investors in the plans). The reporting module 190 is configured such that plan participants can be automatically sent packages of fund information with respect to proposed or actual fund changes in the plan in which they are participants. In particular, this information can be sent on behalf of or via the RPF and in compliance with notification requirements that may be in place.

The system 100 is intended to provide support services and not investment advice such that the entity hosting the system 100 does not assume a co-fiduciary role.

The system 100 is further intended to and configured to provide a manageable number of fund changes within a predetermined period. Through research and review of quantitative and qualitative studies, it was found that RPFs and plan participants were uncomfortable with a high level of fund turnover (sometimes referred to as “fund churn”). It was determined that the fund turnover should be low enough as to not have excessive fund turnover, but also include one or more predetermined thresholds where underperforming funds would be identified and replacements could be suggested. In some cases, the system 100 may suggest replacing one or two underperforming funds in a predetermined period such as a quarter or a year. The system 100 may include a predetermined threshold for funds, and funds performing below the predetermined threshold may be the underperforming funds the system 100 will report to the RPF. The system 100 is intended to provide the prescribed threshold such that a reasonable number of funds may be reported as underperforming but also providing opportunities for funds no longer meeting the plan's IPS to be removed and replaced. In some cases, there may also be a second predetermined threshold such that, if the number of underperforming funds is more than the second predetermined threshold, only the worst performing funds below the second predetermined threshold are reported. In some cases, the predetermined thresholds may be used to identify underperforming funds as well as funds to watch, as the performance of the watched funds may have deteriorated over a predetermined period of time as described herein.

FIG. 2 illustrates a flow chart of an embodiment of a method 200 of an initial plan set-up. In particular, the method 200 provides for an initial fund line-up for the plan, Wherein the initial fund line-up consists of a plurality of funds that are designed to meet the IPS of the plan.

At 210, the RPF selects or determines a theme for the plan based on the IPS. Table 1 shows several predetermined and the weightings applied to a plurality of criteria under each theme. A theme and the weights assigned are referred to as a “criteria option”. For example, the RPF, on review of the IPS, may determine a plan theme, such as “performance” as being is a key aspect of the plan. The RPF could then choose a “performance” criterion option. In other cases, “risk” may be considered a more important theme and the RPF may select a predetermined “risk-protection” theme. In other cases, as shown at 220, the RPF may choose to create a custom option based on a specified weighting of the criteria.

The system 100 is intended to simplify the selection of funds for the RPFs yet continue to allow the RPFs to pick the criteria that best fit the plan's needs. The system 100 automatically generates at least one predetermined set of criteria options and fund lists that are theme-based, for example Performance, Expense, Balanced, Risk-protection or the like.

The predetermined criteria options are intended to tailor the criteria for the RPFs in order for them to select criteria that meet the goals and objectives of the IPS. The predetermined criteria options were selected based on research and experimentation to determine options that would provide metrics that could be used to determine funds to be used as an initial fund line-up and to provide a tool for analyzing the funds in the line-up and determining alternative funds if necessary. The predetermined criteria options are intended to allow for appropriate metrics to be used in the systems and methods for plan investment management.

The predetermined criteria options were further modified in relation to review of historical data and further experimentation. In a comprehensive review followed by further testing, the theme-based criteria options were created and weighted. The predetermined criteria options are intended to provide a system tool allowing the characteristics of the predetermined options to be used in weighting and analyzing funds that may then be considered by the RPF for the plan.

If none of the predetermined criteria options suit the Plan's needs, the RPF can create a completely custom criteria option by specifying a plurality of criteria and weighting the custom criteria. The predetermined criteria option weighting may be applied to the measurement to determine the weighting of the criteria. The system 100 can create a customized fund line-up based on the criteria option. The criteria the RPF selects, either predetermined or custom criteria, are captured in the plan's formal Investment Policy Statement and may be used as part of the ongoing investment due diligence.

Table 1 also illustrates a plurality of objective criteria to be used for the plan investment management. Each criterion is related to a quantitative measurement. For example, the criterion of “fund level fees” is related to a measurement based on “expense ratio”. The system 100 allows the RPF to select a plurality of criteria that will be used to select an initial fund line-up. The system 100 may provide a list of predetermined criteria, an example of which is shown in Table 1, or the RPF may create custom criteria by, for example, selecting a combination of quantitative measurements the RPF wishes to use in the analysis of the funds.

TABLE 1

| | | Predetermined | | | | |
|---|---|---|---|---|---|---|
| | | Criteria Option | | | | |
| | | | | | Risk- | |
| Criteria | Measurement | Performance | Expense | Balanced | Protection | Custom |
| 3-year performance | 3-year return | 20% | 10% | 20% | 0% | 0% |
| Actual vs. expected performance | Alpha | 0% | 0% | 0% | 0% | 0% |
| Risk-adjusted performance using T-bill | Sharpe ratio | 40% | 10% | 15% | 20% | 0% |
| return | | | | | | |
| Risk-adjusted performance using | Information ratio | 0% | 0% | 0% | 0% | 60% |
| benchmark return | | | | | | |
| Correspondence to stated investment style | R-squared | 0% | 0% | 0% | 0% | 0% |
| Performance in up markets relative to | Upside capture | 10% | 10% | 15% | 10% | 0% |
| benchmark | | | | | | |
| Performance in down markets relative to | Downside capture | 10% | 10% | 15% | 40% | 0% |
| benchmark | | | | | | |
| Portfolio risk | Standard deviation | 0% | 0% | 0% | 0% | 0% |
| Systematic risk | Beta | 0% | 0% | 0% | 10% | 0% |
| Fund level fees | Expense ratio | 20% | 60% | 35% | 20% | 40% |

In particular, under a custom option, the RPF may select individual criteria for the plan analysis as opposed to selecting a theme. The RPF may select criteria, for example, “portfolio risk” and “fund level fees”, as these criteria may be considered important on review of the IPS. In another example, an RPF may wish to use only “risk adjusted performance using benchmark return” and “fund level fees” and specify a weight for each measurement such as a 60% weighting of “information ratio” and a 40% weighting of “expense ratio”. Various combinations and weightings of the criteria are possible within the custom option and may depend on the IPS of the plan.

In some cases, the system 100 may allow a predetermined number of criteria to be selected and weighted by the RPF. Having a limited number of criteria prevents the possible dilution of criteria to the point that the custom option no longer matches the IPS for the plan. The system 100 further stores the theme and criteria selected by the RPF to be used in further analysis of the funds within a plan.

At 230, the system 100 then retrieves fund data and the measurements related to each criterion. At 240, the analysis module 160 analyzes the fund data in relation to the weighted criteria. At 250, the analysis module objectively ranks the funds available in the investment platform based on the analysis. The analysis module 160 may retrieve fund data captured by the monitoring module 150 and stored in the memory module 180. In some cases, each fund is assigned to a Morningstar™ category (asset class) based on its underlying mutual fund. The fund may be assigned a ranking by comparing it to all other mutual funds within the same Morningstar™ category using the weighted criteria for the plan. In other cases, other fund classifications or a plurality of fund classifications may be used to compare and rank funds.

The selection component 170 identifies the highest ranking funds in each of the designated categories. At 260, the reporting module 180 reports the funds to the RPF. At 270, the reporting module may further use these funds to select 270 a custom fund line-up for the plan for the RPF to review.

FIG. 3 illustrates a flowchart of an example method 300 of plan review. It is intended that the system 100 reviews and analyzes the funds selected for the plan at a predetermined time interval. In some cases, the system 100 will review and reanalyze the plan yearly. In other cases, the system 100 may review and reanalyze the plan at more frequent intervals, for example, daily, monthly, quarterly, or the like. In some cases, the method 300 of fund and plan analysis may be initiated by the RPF. In other cases, the system 100 may remind the RPF and/or Financial Representatives of an upcoming review.

The monitoring module 150 monitors the funds in the plan. The monitoring module 150 collects and stores data related to the funds to be used in the analysis of the funds. The fund data may be collected through external systems used to classify funds. At 310, the analysis module 160 retrieves the fund data and the criteria option (i.e. weighted criteria) previously selected by the RPF and saved in the memory module 190.

At 320, the analysis module 160 will analyze and rank the funds in relation to the criteria option. At 330, the analysis module may add funds to a warning list based on the analysis. As each fund is ranked, funds that are in a lower ranking may be placed on a warning list. The evaluation of the ranking may also be based on the time period that the fund has been at a lower ranking. For example, a fund holding a fund ranking of 51 to 100 (where 1 is best and 100 is worst) for the last four calendar quarters prior to the analysis may be placed on the warning list.

The ranking of the funds is intended to notify the RPF of underperforming funds that the RPF may wish to replace. In some cases, the ranking is configured such that only a small number of funds are placed on the warning list during each review. The warning list is intended to alert the RPF of underperforming funds but not generate an excessive amount of fund churn for the plan. In some cases, the ranking of the funds is configured to generate one or two funds that should be brought to the attention of the RPF as underperforming funds.

At 330, the analysis module 160 may also add funds to a watch list. The watch list may include funds with a lower ranking but for a shorter period of time, such that the funds may not yet warrant being placed on the warning list. For example, a fund that has fallen within a fund ranking range as described above for only the last 3 calendar quarters preceding the analysis, may be placed on the watch list.

At 340, for funds on the warning list, the selection component 170 of the system 100 determines an alternative fund for the plan as a fund with the highest objective fund ranking in the same designated asset class for replacement consideration by the RPF. In some cases, only the highest ranked fund may be selected for reporting to the RPF for consideration. In other cases, the selection module 170 may select a plurality of funds as alternatives to the fund on the warning list, for example if there is a tie in the ranked funds or if the RPF prefers to review additional options. In still other cases, the selection module 170 may select a plurality of funds as alternatives to the fund on the warning list if each fund in the plurality of funds meets a predetermined target rating. The selection component 170 may further select alternative funds for funds on the watch list in a similar manner.

At 350, the reporting module 190 creates a report which is transmitted to the RPF to review. The RPF and other authorized users may also have the option to review the results of the review online or the RPF may be sent a hardcopy of the report. The report may include updated objective fund ranking data and information for all funds in the plan monitored by the system 100; and may further include the warning and watch lists identifying any monitored funds that no longer meet the specified criteria. The report also lists alternative funds for the funds on the warning list. In some cases, the report may further list alternative funds for funds on the watch list.

In some cases, the RPF may submit a request to the system to replace a fund on the warning list or on the watch list with the suggested alternative fund or another replacement fund. Typically the replacement fund will be in the same designated class identified by the system 100. In some cases, the RPF can specify an effective date for the fund changes and the system 100 will ensure the funds are changed on the effective date; the processor 140 of the system may effect the change or may provide instructions to an external trading system (not shown) to process the change on the effective date.

In some cases, the effective date will be determined by the system 100. The system 100 may determine the date based on any required notice period for the plan participants of the plan, for example, if the required notice period is between 30 and 90 days the system 100 may select an effective date 45 days in the future as the effective date. In other cases, the system 100 may select an effective date within the required notice period, and the RPF may have the option to change the effective date to another date. In other cases, the RPF may select an effective date within a time period displayed by the system, wherein the time period is based on the required notice period for the plan participants of the plan. The system 100 will automatically process the changes on the effective date and notify the RPF when the requested changes are completed.

At 360, the report module 190 prepares plan participant notification packages. As RPFs are often required to notify plan participants and beneficiaries in advance of any funds changes taking effect. The report module 190 may be configured to may automatically prepare a notification package that includes a customized letter to plan participants and the appropriate fund information for each replacement fund.

The notification package may include information on both the warning list or watch list funds requested to be eliminated and the designated replacement funds. The notification package may also include information on any redemption fees applicable to the replacement funds and where plan participants can go to receive additional information, make alternative selections or change their ongoing investment instructions. In some cases, the notification packages can be downloaded and emailed or printed by the RPF. The notification package is intended to provide the participants with information in order for the participants to remain informed on proposed changes to their investments within the plan.

At 370, the system 100 tracks the selection of any plan participant who wishes to opt-out of the fund change or make an alternative selection with respect to the RPF suggested fund change. In some cases, details on the plan participants who opt-out of the change will be stored in the memory module 180.

At 380, the system 100 or processor 140 processes the change on the effective date. The system 100 may ensure that the plans for plan participants that opted out of the change requested by the RPF have no change processed on the effective date. Further, the system 100 will process any alternative changes requested by plan participants that requested an alternative fund as opposed to the fund selected by either the system 100 or the RPF. In ensuring the plan participants' selections are met, the system 100 is intended to allow the RPF to meet the fiduciary responsibilities in administering the plan while still allowing the plan participants to amend or modify the changes proposed by the RPF.

At 390, after the fund change has occurred on the effective date, the system 100 will notify the RPF of the completed fund change. The RPF will receive details with respect to the fund change and may receive further details with respect to plan participants who have opt-out of the fund change or who have selected an alternative fund change.

In some cases, a fund change may be initiated by a plan participant and may be with respect to a fund that is not on a warning list or watch list. The system 100 is configured to process the requested change by the plan participant. In future analysis and review of the plan, the system 100 will review the funds to determine if the funds are underperforming and the RPF of the plan should consider alternative funds to replace the underperforming funds.

In a specific example, the system 100 may further provide additional features to the RPF. In some cases, the system 100 may allow an RPF to view and update, when necessary, the criteria option to ensure that the criteria option continue to properly represent the IPS and goals of the plan. The RPF may modify the previously selected and stored criteria option and, in some cases, the criteria or further specify new criteria options or criteria, either by selecting predetermined criteria options or criteria and measurements or by creating custom criteria options or criteria. On changes to the selected criteria option, the system 100 may review the current fund line-up to determine if the selected funds still meet the new criteria option selected by the RPF. The system 100 may rank funds and determine that, with the new criteria option, certain funds are underperforming. The underperforming funds and alternative funds may then be reported to the RPF.

The system 100 may also allow the RPF to review data and statuses of upcoming, pending or in progress analysis of the plan. The RPF may also request an analysis of the plan or, in some cases, of a particular fund within the plan. The requested analysis may include a review against all the criteria or against a subset of criteria to review a specific aspect of the plan.

In some cases, the system 100 may further allow for the viewing and reporting of historical changes within a plan. The RPF may review historical changes made to the plan with respect to underperforming funds or funds that have previously been on a watch list but subsequently removed from the watch list as the fund improved its performance.

In the preceding description, for purposes of explanation, numerous details are set forth in order to provide a thorough understanding of the embodiments. However, it will be apparent to one skilled in the art that these specific details may not be required. In other instances, well-known structures are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for investment plan management comprising:
determining criteria for analysis of a plurality of funds;
weighting the criteria;
analyzing the plurality of funds, wherein analyzing comprises
retrieving fund data with respect to each fund of the plurality of funds;
analyzing the fund data in relation to the weighted criteria;
ranking each fund based on the analysis;
reporting the ranking of each fund of the plurality of funds; and
selecting funds for the plan.

2. The method of claim 1 further comprising:
determining at least one alternative fund for any underperforming fund that ranks below a predetermined threshold ranking.

3. The method of claim 2 further comprising:
preparing plan participant notification packages comprising detail on the at least one alternative fund and the underperforming fund.

4. The method of claim 2 further comprising:
processing a change from the underperforming fund to the at least one alternative fund.

5. The method of claim 4 wherein the change is processed on an effective date wherein the effective date is within a required notice period.

6. The method of claim 4 further comprising:
tracking plan participants who select to opt out of the fund change.

7. The method of claim 1 wherein the ranking of the plurality of funds is used to determine an initial fund line-up for a plan.

8. The method of claim 1 wherein the criteria are predetermined criteria.

9. The method of claim 1 wherein the criteria are custom criteria as selected by a plan administrator.

10. The method of claim 1 wherein the weighting of the criteria is determined based on a predefined set of criteria options.

11. A system for plan investment management comprising:
a monitoring module for retrieving fund data with respect to each fund of a plurality of funds;
an analysis module configured to determine and weight criteria for analysis of each fund within the plurality of funds, the analysis module further configured to analyze the fund data in relation to the weighted criteria and rank each fund based on the analysis;
a reporting module configured to rank each fund within the plurality of funds; and
a selection component configured to select funds for the plan.

12. The system of claim 11 wherein the analysis module is further configured to determine at least one alternative fund for any underperforming fund which ranks below a predetermined threshold ranking.

13. The system of claim 12 wherein the reporting module is further configured to prepare plan participant notification packages comprising detail on the at least one alternative fund and the underperforming fund.

14. The system of claim 12 further comprising:
a processing module configured to process a change from the underperforming fund to the at least one alternative fund.

15. The system of claim 12 wherein the change is processed on an effective date wherein the effective date is within a required notice period.

16. The system of claim 12 further comprising:
a memory module configured to track plan participants who select to opt out of the fund change.

17. The system of claim 11 wherein the selection component is further configured to use the ranking of the plurality of funds to determine an initial fund line-up for a plan.

18. The system of claim 11 wherein the criteria are predetermined criteria.

19. The system of claim 11 wherein the criteria are custom criteria as selected by a plan administrator.

20. The system of claim 11 wherein the weighting of the criteria is determined based on a predefined set of criteria options.
